(19) United States
(12) Patent Application Publication
(10) Pub. No.: US 2014/0074822 A1
(43) Pub. Date: Mar. 13, 2014

(54) METHOD AND SYSTEM FOR EFFECTIVE SEARCH RETARGETING IN SEARCH ADVERTISING

(71) Applicant: NHN Business Platform Corporation, Seongnam-si (KR)

(72) Inventor: Yungseong LEE, Seongnam-si (KR)

(73) Assignee: NHN Business Platform Corporation, Seongnam-si (KR)

(21) Appl. No.: 14/022,768

(22) Filed: Sep. 10, 2013

(30) Foreign Application Priority Data
Sep. 10, 2012 (KR) 10-2012-0100025

(51) Int. Cl. G06F 17/30

(52) U.S. Cl. CPC G06F 17/30554
USPC 707/722

(57) ABSTRACT

Provided is a method and system for effective search retargeting in search advertising. An advertising method may include determining a search history of a user and changing a display text associated with the search result if the determining determines that the search result has been previously provided to the user. The determining may be based on a search result provided to the user in response to a received input keyword.

### CROSS-REFERENCE TO RELATED APPLICATION

This application claims priority from and the benefit of Korean Patent Application No. 10-2012-0100025, filed on Sep. 10, 2012, which is hereby incorporated by reference for all purposes as if fully set forth herein.

### BACKGROUND

1. Field

Example embodiments relate to a method and system for effective search retargeting in search advertising.

2. Description of the Background

In search advertising, many users generally conduct a search multiple times using a single keyword. Also, users conduct a search using a variety of keywords to obtain desired search results. For example, a user who desires to take a trip to “Gangwon-do” may conduct a search by inputting a keyword “Gangwon-do reservation” over several days and may also conduct a search by inputting a variety of keywords, such as “Gangwon-do spa reservation” and “Gangwon-do couple reservation”, in addition to “Gangwon-do reservation”.

Also, advertisers may desire to obtain a large amount of traffic by purchasing a large number of relevant keywords if possible, instead of purchasing a single keyword.

Due to the aforementioned tendency of the users and the advertisers, an advertising text of the same advertiser may be displayed to the same user several times during a website selection process when conducting a search. However, in a case in which a site that has been verified once by a user is displayed again, a click on the site is highly unlikely to occur.

In the conventional art, a purple flag is set at a link to a site that has been selected and verified once by the same user, and the same advertising text is displayed for the same advertisement. Additionally, a previously visited and/or accessed link may be displayed in a distinguishing way, such as in a different color (e.g., typically a purple color), font, typeface, or other like distinguishing feature. For example, assume the keywords “Gangwon-do reservation” and “Gangwon-do spa reservation” are matched to advertisement “N reservation”. When a user clicks on a link to the advertisement “N reservation” from a search result associated with the keyword “Gangwon-do reservation”, the link to the advertisement “N reservation” which is included in a subsequent search result associated with the keyword “Gangwon-do spa reservation” is marked in purple. Therefore, the user may easily verify a site that the user has visited at least once. In this case, a level of interest of the user on the previously visited site may be relatively low compared to other sites. Also, assume that the user reads an advertising text of the advertisement “N reservation” from the search result associated the keyword “Gangwon-do reservation” and does not select the advertisement “N reservation”. In this case, the same advertising text of the advertisement “N reservation” is provided as the search result associated with the keyword “Gangwon-do spa reservation” and thus, it is still highly probable that the user may not select the advertisement “N reservation”.

However, to display the same advertisement in the search results retrieved by a user using a variety of keywords indicates that the advertisement is likely to meet the needs of the user. That is, a search result displayed many times is likely to have a relatively high conversion rate compared to a newly proposed search result. However, once a page is opened, a purple flag indicating that the user has visited the page is repeatedly displayed on the same advertising text, even if the user had left the page immediately. Accordingly, the user may avoid the page, which may result in lowering a conversion rate.

### SUMMARY

Example embodiments relate to an advertising system and method that may change and provide an advertising text to a user based on a variety of conditions, such as a search history, a search result, and/or a reaction history. Additional features of the example embodiments will be set forth in the description which follows, and in part will be apparent from the description, or may be learned by practice of the example embodiments.

According to an example embodiment, an advertising method is provided. The advertising method may include determining a search history of a user and changing a display text associated with the search result if the determining determines that the search result has been previously provided to the user. The determining may be based on a search result provided to the user in response to a received input keyword.

In one example embodiment, the advertising method may further include storing a plurality of level-by-level display texts and matching each of the plurality of level-by-level display texts with the input keyword. Each of the plurality of level-by-level display texts includes a level.

In one example embodiment, the changing may include determining a level of the display text associated with the search result and displaying another one of the plurality of level-by-level display texts. The display text may be one of the plurality of level-by-level display texts and the other one of the plurality of level-by-level display texts may be associated with the search result and may have a subsequent level to the determined level.

In one example embodiment, the changing may include determining another keyword associated with the input keyword, creating additional information based on a comparison of the input keyword and the other keyword, and adding the additional information to the display text associated with the search result. The other keyword may be based on the search history of the user.

In one example embodiment, the changing may include determining another keyword associated with the input keyword, creating additional information based on a comparison of the input keyword and the other keyword, extracting a character string from at least one of the plurality of level-by-level display texts, and adding the additional information and the extracted character string to the display text associated with the search result. The other keyword may be based on the search history of the user. The extracted character string may be associated with the additional information.

In one example embodiment, the determining may include determining a reaction history of the user and changing a landing page of a site based on the search result and the reaction history.

In one example embodiment, the determining may further include determining a reaction history of the user and adding promotion information to the display text of the search result using the determined reaction history.

In one example embodiment, the reaction history of the user may include at least one of a site selection, an amount of time the user visits a site, a page viewed within a site, and an occurrence of conversion.

According to an example embodiment, an advertising system is provided. The advertising system may include a processor including a search history verifying module configured to determine a search history of a user and a display text changing module configured to change a display text associated with the search result if the search history verifying module verifies that the search result has been previously provided to the user. The determination may be based on a search result provided to the user in response to an input keyword.

In one example embodiment, the advertising system may further include a database including a display text storage configured to store a plurality of level-by-level display texts, where each of the plurality of level-by-level display texts include a level, each of the plurality of level-by-level display texts are matched with the input keyword. The display text changing module may be further configured to determine a level of the display text and to display another one of the plurality of level-by-level display texts, the display text is one of the plurality of level-by-level display texts. The other one of the plurality of level-by-level display texts may be associated with the search result and may have a subsequent level to the determined level.

In one example embodiment, the display text changing module is configured to determine another keyword associated with the input keyword to be provided with the search result, the other keyword being based on the search history of the user, create additional information based on a comparison of the input keyword and the other keyword, and add the additional information to the display text associated with the search result.

In one example embodiment, the advertising system may further include a database including a display text storage configured to store a plurality of level-by-level display texts, where each of the plurality of level-by-level display texts include a level, and each of the plurality of level-by-level display texts are matched with the input keyword. The display text changing module may be configured to determine another keyword associated with the input keyword to be provided with the search result, create additional information based on a comparison of the input keyword and the other keyword, extract a character string from at least one of the plurality of level-by-level display texts, and add the additional information and the extracted character string to the display text associated with the search result. The other keyword may be based on the search history of the user. The extracted character string may be associated with the additional information.

In one example embodiment, the search history verifying module is further configured to determine a reaction history of the user and the processor further includes an extending and changing module configured to change a landing page of a site based on the search result and the search history.

In one example embodiment, the extending and changing module is further configured to add promotion information to the display text of the search result using the verified reaction history of the user.

According to an example embodiment, an advertising method is provided. The advertising method includes storing a received plurality of level-by-level advertising texts from an advertiser associated with a keyword, and selecting a single advertising text from among the plurality of level-by-level advertising texts based on a search result to be provided to a user and at least one of a search history of the user and a reaction history of the user. Each of the plurality of level-by-level advertising texts may include a level.

In one example embodiment, the selecting includes determining a level of a display text to be displayed to the user and displaying another display text having a subsequent level to the determined level. The display text may be based on a search result, and the search result may be based on an input keyword. The displaying may be based on at least one of the search history and the reaction history, and the other display text may be the selected advertising text.

In one example embodiment, the advertising method further includes determining another keyword to be provided with the search result, creating additional information based on a comparison of the keyword and the other keyword, and adding the additional information to the display text associated with the search result. The other keyword may be based on the search history of the user.

In one example embodiment, the advertising method further includes determining another keyword to be provided with the search result, creating additional information based on a comparison of the keyword and the other keyword, and extracting a character string associated with the additional information from the plurality of level-by-level advertising texts and further adding the extracted character string to the selected advertising text. The other keyword may be based on the search history of the user.

In one example embodiment, the advertising method further includes adding promotion information to the selected advertising text. The promotion information may be based on the reaction history of the user.

In one example embodiment, the reaction history of the user includes at least one of a site selection, an amount of time the user visits a site, a page viewed within a site, and an occurrence of conversion.

According to an example embodiment, a method for providing a display text with a search result is provided. The method may include receiving an input keyword provided by a user, the input keyword being associated with a display text; receiving a search result based on the input keyword; determining whether the search result and the display text have been previously provided to the user based on a search history of the user; and providing the search result and another display text to the user if the determining determines that the display text has been previously provided to the user.

In one example embodiment, the display text may include a rank and the other display text may include a rank; and the rank of the other display text may be lower than the rank of the display text.

In one example embodiment, the method may further include determining another keyword associated with the input keyword, the other keyword being based on the search history of the user; creating additional information based on a comparison of the input keyword and the other keyword; and providing the additional information with the search result.

In one example embodiment, wherein the display text and the other display text are among a plurality of display texts, the method may further include extracting a character string from at least one of the plurality of display texts, the extracted character string may be associated with the additional information; and providing the additional information and the extracted character string with the search result.

In one example embodiment, the method may further include determining a reaction history of the user, generating promotion information based on the reaction history, and providing the promotion information with the search result.

It is to be understood that both the foregoing general description and the following detailed description are explanatory and are intended to provide further explanation of the example embodiments as claimed.

### BRIEF DESCRIPTION OF THE DRAWINGS

The accompanying drawings, which are included to provide a further understanding of the example embodiments and are incorporated in and constitute a part of this specification, illustrate example embodiments, and together with the description serve to explain the principles of the example embodiments.

FIG. 1 illustrates a communications network according to an example embodiment.

FIG. 2 illustrates an example of a table in which a plurality of advertising texts is set for a single keyword according to an example embodiment.

FIG. 3 illustrates an example of providing additional information in response to a keyword input from a user for a previous search according to an example embodiment.

FIG. 4 illustrates an example of providing a search result using a plurality of advertising texts and additional information according to an example embodiment.

FIG. 5 illustrates an example of changing a landing page according to an example embodiment.

FIG. 6 illustrates an example of providing promotion information as additional information according to an example embodiment.

FIG. 7 illustrates an internal configuration of an advertising system according to an example embodiment.

FIG. 8 illustrates an advertising method according to an example embodiment.

FIG. 9 illustrates an example of a method of changing a display text according to an example embodiment.

FIG. 10 illustrates another example of a method of changing a display text according to an example embodiment.

FIG. 11 illustrates still another example of a method of changing a display text according to an example embodiment.

FIG. 12 illustrates an internal configuration of an advertising system according to another example embodiment.

FIG. 13 illustrates an advertising method according to another example embodiment.

### DETAILED DESCRIPTION OF EXAMPLE EMBODIMENTS

The example embodiments are described more fully hereinafter with reference to the accompanying drawings. This example embodiments may, however, be embodied in many different forms and should not be construed as limited to the example embodiments set forth herein. Rather, these example embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

Example embodiments, may, however, be embodied in many different forms and should not be construed as being limited to the embodiments set forth herein; rather, these example embodiments are provided so that this disclosure will be thorough and complete, and will fully convey the scope of example embodiments to those of ordinary skill in the art. In the drawings, the thicknesses of layers and regions are exaggerated for clarity. Like reference numerals in the drawings denote like elements, and thus their description may be omitted.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein the term “and/or” includes any and all combinations of one or more of the associated listed items. Other words used to describe the relationship between elements or layers should be interpreted in a like fashion (e.g., “between” versus “directly between,” “adjacent” versus “directly adjacent,” “on” versus “directly on”).

It will be understood that, although the terms “first”, “second”, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of example embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Expressions such as “at least one of,” when preceding a list of elements, modify the entire list of elements and do not modify the individual elements of the list.

Example embodiments are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of example embodiments.

Unless otherwise defined, all terms (including technical and scientific terms) used herein have the same meaning as commonly understood by one of ordinary skill in the art to which example embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

Hereinafter, example embodiments are described in detail with reference to the accompanying drawings.

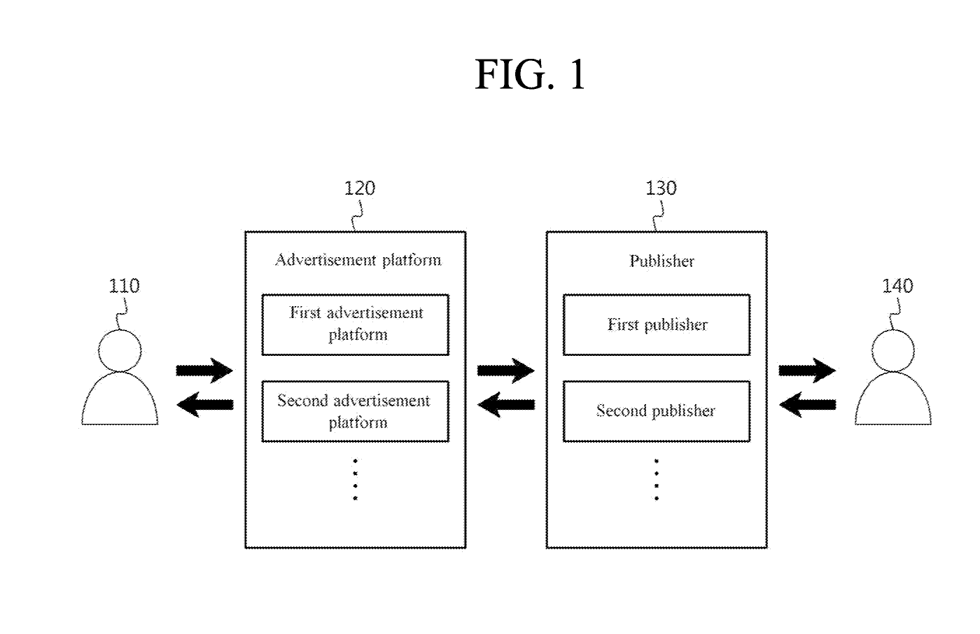

FIG. 1 illustrates a communications network including an advertiser 110, an advertisement platform 120, a publisher 130, and a user 140 according to an example embodiment.

Referring to FIG. 1, the advertiser 110, the advertisement platform 120, the publisher 130, and the user 140 (the “components of FIG. 1”) are individually illustrated. It should be noted that the devices as shown in FIG. 1 may be hardware computing devices capable of sequentially and automatically performing a sequence of arithmetic or logical operations; equipped to record/store digital data on a machine readable medium; and transmit and receive digital data via one or more network devices. The devices of FIG. 1 may be configured to send/receive data to/from network devices, such as a router, switch, or other like network devices, via a wired or wireless connection. The devices as shown in FIG. 1 may include user terminals, such as personal computers (PCs), smart phones, tablet PCs, and/or any other physical or logical device capable of recording, storing, and/or transferring digital data via a connection to a network device. Additionally, the arrows as shown in FIG. 1 indicate that data may be transmitted and received between a user terminal associated with the advertiser 110 and user terminals associated with the advertisement platform 120, the publisher 130, and the user 140 over a wired/wireless network.

The advertisement platform 120 may include a system for performing bidding on an advertisement of the advertiser 110, matching an advertisement with a keyword, sorting advertisements or advertisers, providing an advertisement to the publisher 130, charging for displaying an advertisement, and/or other like advertisement bidding activities. The advertisement platform 120 may be configured to perform search advertisement functions and/or banner advertisement platform delivery functions via a network, such as the Internet.

The term “publisher” may be interchangeably used with the term “site” and/or “website”. However, the term “site” or “website” is not to be construed as excluding instances where the example embodiments are carried out in an environment in which a website access of a general PC is not performed, such as a website accessed and/or viewed via an application screen executed on a mobile terminal, and/or websites access or viewed via other like devices. The “site” may be compatible with a “publishing site” or a “publisher”. Each site may correspond to an individual publisher, for example, a first publisher and a second publisher included in the publisher 130. Here, the “site” may include a type of website through which an advertisement may be displayed. The site may be provided to a user over a wired or wireless network. The site may include a single webpage configuring a website.

Also, “displaying” information of an advertisement may be interpreted as providing promotional content to a visitor, such as text, an image, a sound, a video, a hyperlink, and/or other like data that is associated with an advertiser (e.g., the user 140 of a corresponding site through the site or the publisher). Further, a “selection” on the displayed advertisement may indicate an occurrence of a situation in which the advertiser intends to deliver the promotional content in such a manner that a user corresponding to a site visitor reacts to the provided promotional content. For example, a situation intended by an advertiser may include a situation in which a page associated with the advertiser is displayed to a user selecting an advertisement and a situation in which a user joins through or visits the displayed page by selecting the advertisement.

In this instance, achieving the situation intended by the advertiser may be expressed as “conversion”. For example, when the situation intended by the advertiser is a “selection”, for example, a click on the displayed advertisement, the “conversion” may correspond to a mouse click of a user or other like indication that a selection has been made. As another example, when the situation intended by the advertiser is sales of a product through the displayed advertisement, the “conversion” may indicate sales of a product that the advertiser desires to sell through the displayed advertisement. As another example, when the situation intended by the user is signing-up or otherwise applying to join a site as a member through the displayed advertisement, the “conversion” may indicate the user's site joining process.

Referring to FIG. 1, the publisher 130 may provide a site of the publisher 130 to the user 140, and may provide one or more pages included in the site to the user 140 through the site. In various embodiments, the publisher 130 may provide a search result associated with a keyword to the user 140 in response to the keyword being input to the site. The publisher 130 may receive, from the advertisement platform 120, one or more advertisements to be displayed through pages and provide the received advertisements to the user 140. For example, the publisher 130 may transfer a keyword input from the user 140 to the advertisement platform 120, and the publisher 130 may receive an advertisement associated with the keyword from the advertisement platform 120 and provide the advertisement to the user 140 as a search result. As another example, the publisher 130 may determine an advertisement to be provided as a search result in response to a keyword input from the user 140, and may request information about the determined advertisement from the advertisement platform 120. The publisher 130 may add, to the search result, information about the advertisement that is received from the advertisement platform 120, and may provide the search result to the user 140.

The publisher 130 may display a path via which the user 140 receives an advertisement. For example, in a general online environment, advertisements may be displayed to the user 140 through a website. Each of a plurality of individual advertisement platforms (e.g., a first advertisement platform and a second advertisement platform included in the advertisement platform 120) may display an advertisement through at least one individual publisher among a plurality of publishers (e.g., a first publisher and a second publisher included in the publisher 130). At least one individual publisher among the plurality of individual publishers may provide the user 140 with at least one service, such as an integrated search, a keyword search, a blog service, a mail service, and a social network service. Services provided by the publishers may be provided over a wired/wireless network, including displaying of the advertisement.

According to other example embodiments, an individual advertisement platform and an individual publisher may refer to systems included in a single system.

An advertising system according to example embodiments may refer to a system included in the aforementioned individual advertisement platform or individual publisher, or may refer to a system connected thereto.

Among search results retrieved by a user using a variety of keywords, a search result displayed many times is highly likely to meet the needs of the user. The search result displayed many times may be a search result having a relatively high conversion rate compared to a newly proposed search result.

Additionally, in situations where a purple flag and/or other like distinguishing feature indicating that a user has visited a site that is displayed as part of the displayed search results is not set, a probability that the search result may be deviated from is lowered. Indicating a link in color relates to a policy issue and has been applied to an actual advertisement service. However, in this case, an effect obtained by indicating a site displayed in the search results is a site that a user has visited may confuse the user, especially if the site corresponds to a result meeting the search needs of the user. Further, a user may be confused if a previously visited site is not indicated using the purple flag or other distinguishing feature. Also, in a case in which a user opens the same site casually and recognizes that the user has visited the site and then leaves the site immediately, costs associated to click is charged to an advertiser, even though the click may have a low conversion rate.

According to an example embodiment, with respect to the same search result repeatedly provided to a user through a search conducted many times, information different from previously displayed information may be provided or additional information may be included in the previously displayed information and/or search results.

For example, instead of matching a single advertising text to a single keyword, a plurality of advertising texts may be matched to a single keyword. When a user conducts a search many times using the same keyword, information of a search result displayed through the search conducted many times may be changed to be different from previously displayed information. The plurality of advertising texts may be sequentially displayed based on one or more conditions. A “condition” may include a search history of the user, a reaction history of the user, and/or other like conditions.

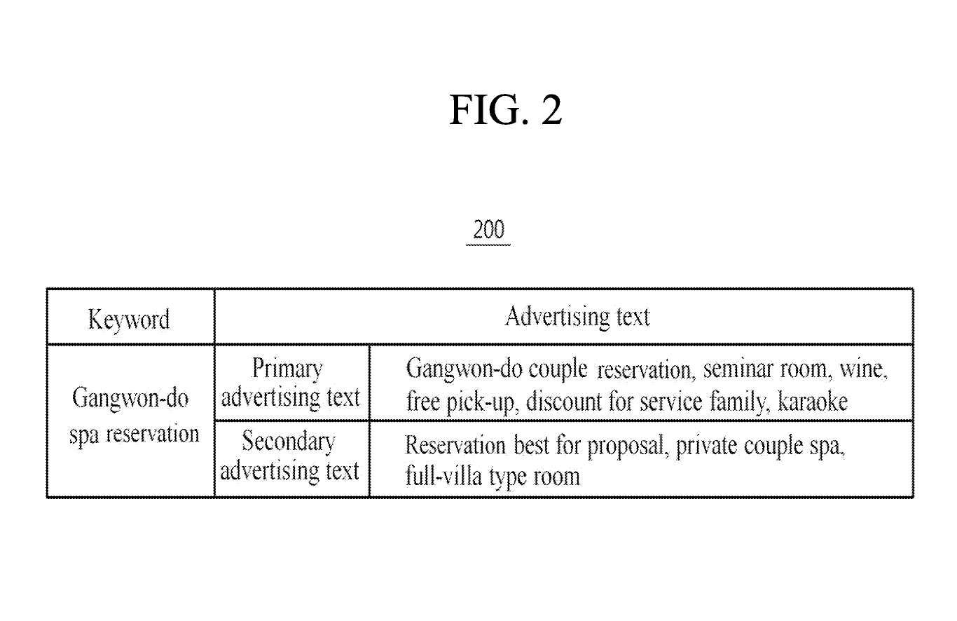

FIG. 2 illustrates an example of a table 200 in which a plurality of advertising texts is set for a single keyword according to an example embodiment. Referring to the table 200, a primary advertising text and a secondary advertising text are matched to keyword “Gangwon-do spa reservation”. If a user A conducts a first search using the keyword “Gangwon-do spa reservation”, the primary advertising text “Gangwon-do couple reservation, seminar room, wine, free pick-up, discount for service family, karaoke” may be displayed to the user A. If the user A conducts a second search using the keyword “Gangwon-do spa reservation”, the secondary advertising text “reservation best for proposal, private couple spa, full-villa type room” may be displayed to the user A.

By providing information different from previously displayed information with respect to a search result repeatedly displayed to a user based on a search history of the user, it is possible to decrease a probability that the corresponding search result may be excluded from a matter of interest of the user. In the case of advertising texts set in stages, it is possible to induce a click of a user or otherwise attract a user's attention by setting a more direct and eye-catching advertising text for a relatively high stage advertising text. Even though two advertising texts are used as an example in FIG. 2, three or more advertising texts may be matched to a single keyword and sequentially displayed based on one or more conditions.

In various embodiments, even though a user conducts a search many times using a variety of keywords, the same search result may be displayed to the user. For example, in a case in which a user conducts a search twice in an order of keywords “Gangwon-do spa reservation” and “Gangwon-do couple reservation”, advertisement “N reservation” of an advertiser having purchased all of the keywords “Gangwon-do spa reservation” and “Gangwon-do couple reservation” may be repeatedly displayed to the user as a result of the searches using the different keywords. In this case, to emphasize that the corresponding search result meets the needs and/or desires of the user, additional information may be added to previously displayed information.

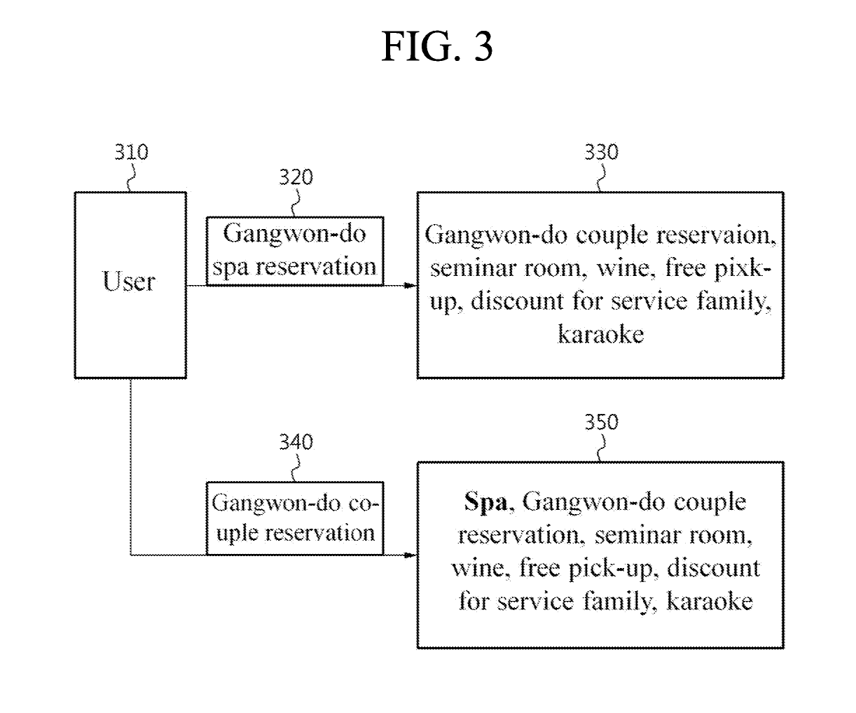

FIG. 3 illustrates an example of providing additional information in response to a keyword input from a user for a previous search according to an example embodiment. Referring to FIG. 3, an advertising text “Gangwon-do couple reservation, seminar room, wine, free pick-up, discount for service family, karaoke” 330 of “N reservation” is displayed as a result of a search conducted in response to a keyword “Gangwon-do spa reservation” 320 input from a user 310. Also, an advertising text “spa, Gangwon-do couple reservation, seminar room, wine, free pick-up, discount for service family, karaoke” 350 of “N reservation” is displayed as a result of search conducted in response to a keyword “Gangwon-do couple reservation” 340 input from the user 310.

The term “spa” is further included in the advertising text 330 of “N reservation” that is previously displayed information, as additional information. The additional information “spa” may be displayed in as an icon or an image, and/or may be displayed to have a size, a color, a thickness different from letters included in the existing advertising text, and/or other like distinguishing features in order to attract the attention of the user 310. The additional information “spa” may be extracted using keywords input from the user 310, as reaction information of the user 310. For example, by comparing the keyword “Gangwon-do spa reservation” 320 input as a first keyword from the user 310 and the keyword “Gangwon-do couple reservation” 340 input as a second keyword from the user 310, it is possible to verify or otherwise determine that the user 310 is interested in “spa”. By adding the additional information “spa” to the existing advertising text, it is possible to emphasize that the corresponding search result meets the needs of the user 310.

If the user 310 inputs “Gangwon-do full villa reservation” as a third keyword and an advertising text of “N reservation” is displayed again, “couple” may be extracted from the keyword “Gangwon-do couple reservation” 340 input from the user 310 as a second keyword and may be added to the existing advertising text of “N reservation” together with “spa”.

A search retargeting method of a first case in which the same search result is repeatedly displayed as a result of search repeatedly conducted using the same keyword and a search retargeting method of a second case in which the same search result is repeatedly displayed as a result of search repeatedly conducted using a variety of keywords are described. Further, it is possible to provide an advertisement by combining two search retargeting methods. For example, in a case in which a plurality of advertising texts is set and maintained for a single keyword as in the search retargeting method of the first case and the first keyword “Gangwon-do spa reservation” and the second keyword “Gangwon-do couple reservation” are input as in the search retargeting method of the second case, “private couple spa” included in the secondary advertising text may be further provided as additional information, instead of simply providing only “spa” as additional information.

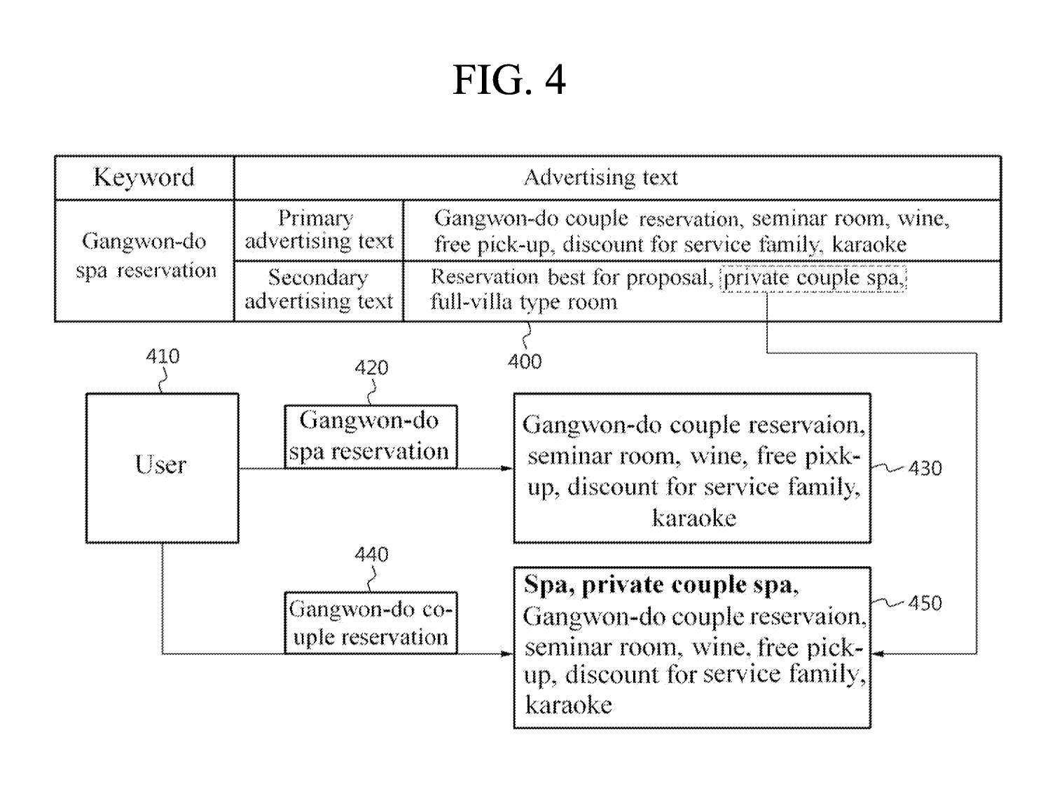

FIG. 4 illustrates an example of providing a search result using a plurality of advertising texts and additional information according to an example embodiment. Similar to the table 200 of FIG. 2, in a table 400 of FIG. 4, a primary advertising text and a secondary advertising text are matched to keyword “Gangwon-do spa reservation”.

Referring to FIG. 4, an advertising text “Gangwon-do couple reservation, seminar room, wine, free pick-up, discount for service family, karaoke” 430 of “N reservation” is displayed as a result of search conducted in response to a keyword “Gangwon-do spa reservation” 420 input from a user 410. Also, an advertising text “spa, private couple spa, Gangwon-do couple reservation, seminar room, wine, free pick-up, discount for service family, karaoke” 450 of “N reservation” is displayed as a result of search conducted in response to a keyword “Gangwon-do couple reservation” 440 input from the user 410. The term “spa” may be additional information extracted through a comparison between two keywords, and “private couple spa” may be additional information extracted from the secondary advertising text based on the additional information “spa”.

As described above, in a case in which the same search result is repeatedly displayed to a user as a result of search repeatedly conducted, information different from previously displayed information may be provided or additional information may be included in the previously displayed information.

Accordingly, it is possible to provide a user with information about a repeatedly displayed search result based on a reaction history of a user in the case of displaying a search result. The reaction history of the user may include a site selection, an amount of time that a user views a site, viewing a certain page a within a site, an occurrence of conversion, and/or other like user reactions.

For example, in a case in which a user clicks on a predetermined search result retrieved through a first search and stays at a site for five seconds or less, when the corresponding search result is to be displayed through a second search, an advertising text may be changed with a secondary advertising text. At the same time, a landing page of the corresponding site may be automatically changed with a page associated with a keyword input from the user.

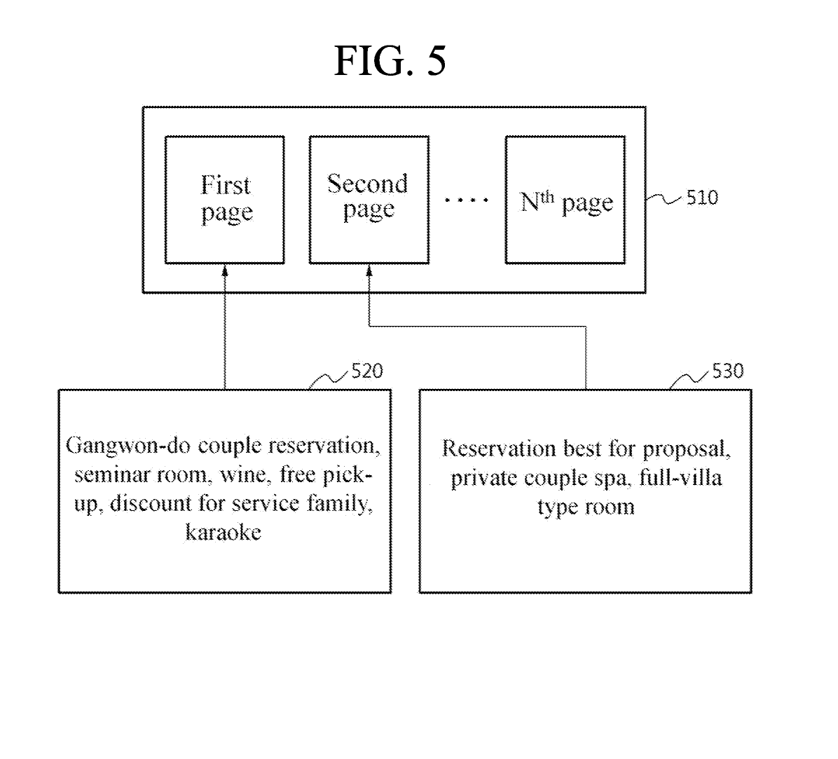

FIG. 5 illustrates an example of changing a landing page according to an example embodiment. A site 510 may refer to an advertisement site including N pages. Referring to FIG. 5, “Gangwon-do couple reservation, seminar room, wine, free pick-up, discount for service family, karaoke” is displayed as a primary advertising text on a first search result page 520. A first page is set as a landing page, a “lead capture page”, or a “lander”. The landing page may be a single page of a site that appears in response to clicking on a search result or an advertisement.

In a case in which a user visits the first page that is the landing page through clicking on a predetermined search result on the first search result page 520 and stays for a relatively short amount of time, such as five seconds or less, an advertising text of the corresponding search result may be changed with a secondary advertising text “reservation best for proposal, private couple spa, full-villa type room” on a second search result page 530 displayed as second search of the user. At the same time, the landing page may be changed with a second page.

That is, if the user stays on a page or visits a site for a relatively short amount of time, the user is likely to have determined that a desired result is absent in the landing page of the site displayed through the first search. Therefore, it is possible to induce an increase in a conversion rate by changing an advertising text and at the same time, automatically changing the landing page with another page at the site. The landing page to be changed may be determined based on a search word of the user or other like criteria.

As another example, even if a user clicks on a predetermined search result retrieved through a first search and stays at a site for ten seconds or more, the user may not implement a conversion, such as site join or product purchase. Accordingly, when the corresponding search result is displayed through a second search, an advertising text including promotion information such as “coupon” may be displayed. For example, a text “5000 won as coupon for join” may be further included as additional information and thereby be displayed. Additionally, or alternatively, another advertising text including a corresponding text may be displayed.

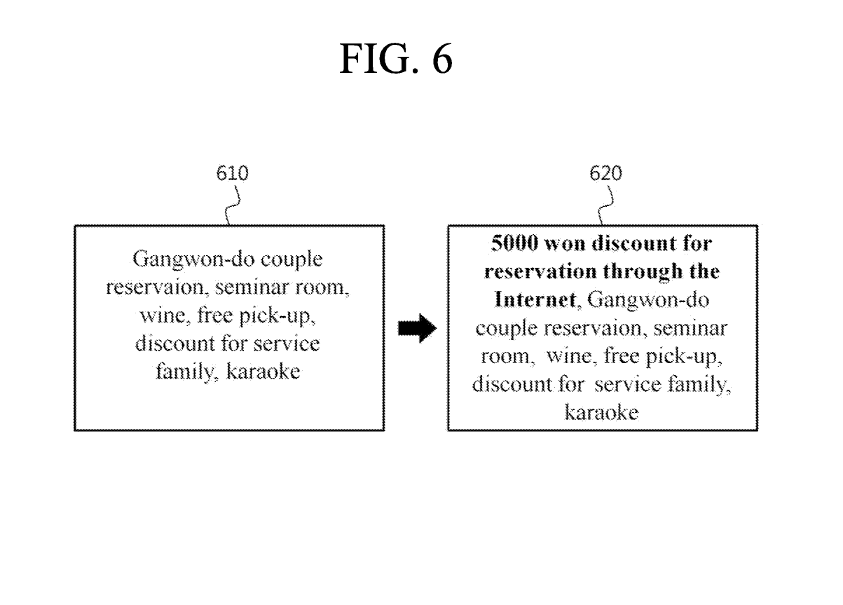

FIG. 6 illustrates an example of providing promotion information as additional information according to an example embodiment. On a first search result page 610, an advertising text “Gangwon-do couple reservation, seminar room, wine, free pick-up, discount for service family, karaoke” of a predetermined search result is displayed as a search result of a user.

In a case in which the user visits an advertisement site of an advertiser through the predetermined search result but does not implement a conversion, additional information “5000 won discount for reservation through the Internet” is included in the advertising text of the predetermined search result as a second search result of the user on a second search result page 620.

As described above, by attracting the attention of a user with respect to a repeatedly displayed search result using a variety of methods, it is possible to prevent the repeatedly displayed search result from being ostracized, ignored, or otherwise disregarded by the user, thereby improving an advertising effect.

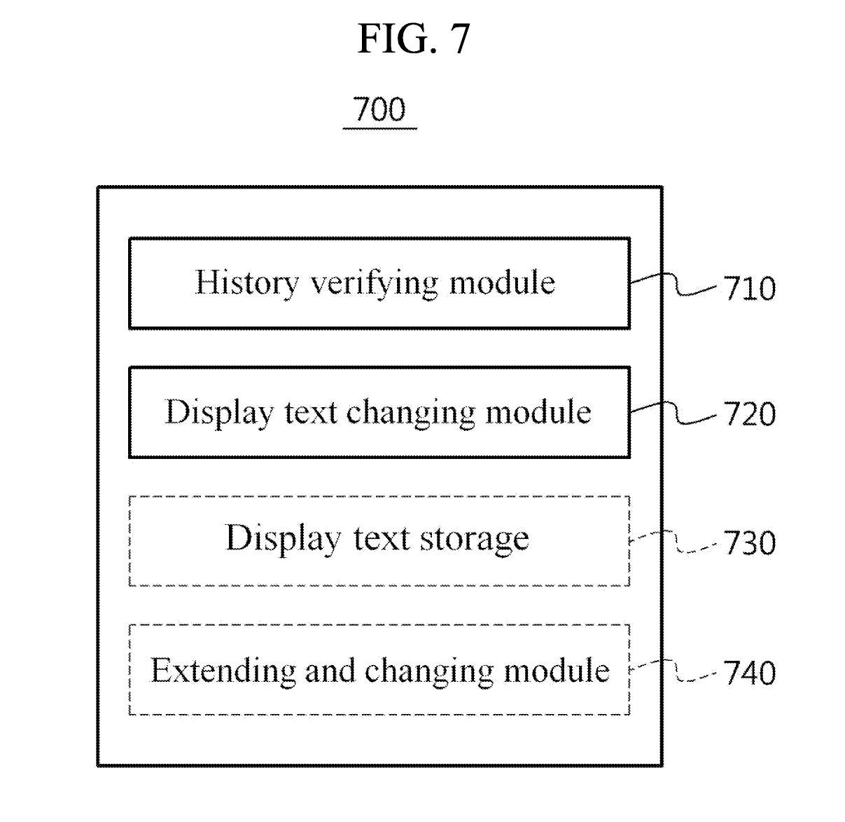

FIG. 7 illustrates an internal configuration of an advertising system 700 according to an example embodiment. Referring to FIG. 7, the advertising system 700 may include a history verifying module 710 and a display text changing module 720. The advertising system 700 may selectively further include a display text storage 730 and an extending and changing module 740. The advertising system 700 may include one or more physical hardware devices, such that the modules of advertising system 700 may be implemented by one or more processors. Additionally, the display text storage 730 may be implemented by one or more hardware storage devices.

The history verifying module 710 may verify a search history of a user with regard to a search result to be provided to the user in response to an input keyword. The search history may at least include information regarding whether the user has been provided with a search result, and a keyword used to provide the user with the search result when the user has been provided with the search result.

The display text changing module 720 may change a display text of the search result when the search result has been provided to the user based on the search history of the user. In a case in which the user has been provided with the search result, a probability that the user selects the search result may be decreased. Accordingly, by changing the display text of the search result, it is possible to attract and/or maintain the attention of the user.

For example, the display text changing module 720 may verify, from the search history of the user, another keyword used to be provided with the search result and may create additional information through a comparison between the keyword and the other keyword. An example of creating additional information “spa” through a comparison between a first keyword “Gangwon-do spa reservation” and a second keyword “Gangwon-do couple reservation”. The created additional information may be added to the display text of the search result in a form of an icon or an image, may be highlighted, and/or otherwise distinguished in order to be distinguishable in the display text of the search result and then be added to the display text of the search result.

The display text storage 730 may store a plurality of level-by-level display texts to be matched to a keyword in association with a search result. The plurality of level-by-level display texts may be a group of display texts associated with one or more keywords, which are arranged by levels. A level may be any type of indication by which one display text is given preference or favored over other display texts, such that display texts having a higher level are displayed more often or more prominently than lower level display texts. The advertising system 700 may selectively provide the plurality of level-by-level display texts based on a search history and/or other criteria. To this end, the display text changing module 720 may verify a level of a display text displayed to the user when the search result has been provided to the user, and may change the display text displayed to the user with a display text corresponding to a subsequent level of the verified level. Such level-by-level display texts may be set to include more direct and eye-catching terms, buzzwords, and/or other like features based on a level.

The display text changing module 720 may extract a character or character string associated with the created additional information from the plurality of level-by-level display texts and further add the extracted character or character string to the display text of the search result.

The extending and changing module 740 may change a landing page of a site according to the search result and/or may add promotion information to the display text of the search result, using a reaction history of the user. The reaction history of the user may be verified by the history verifying module 710. The reaction history of the user may include at least one of an occurrence of a click, an amount of time used for a site stay, a within-site page view, an occurrence of conversion, and/or other like user reactions.

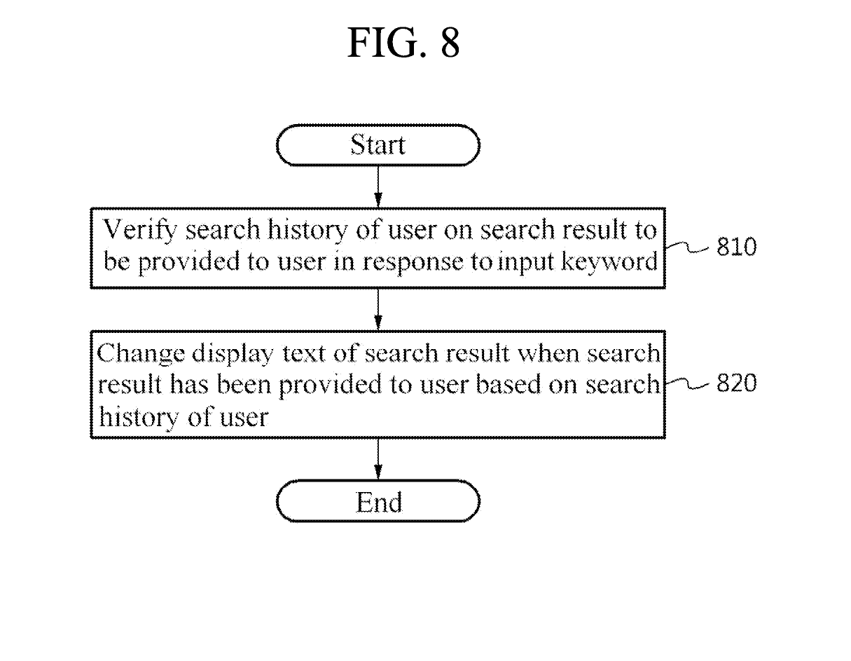

FIG. 8 illustrates an advertising method according to an example embodiment. The advertising method of FIG. 8 may be performed by the advertising system 700 of FIG. 7.

In operation 810, the advertising system 700 may verify a search history of a user on a search result to be provided to the user in response to an input keyword. The search history may include information regarding whether the user has been provided with a search result and a keyword provided with the search result. The search history may also include additional information about the provided search results, such as a conversion rate, a user reaction, and/or other like data pertaining to a user's search history.

Accordingly, in operation 810, the advertising system 700 may further verify a reaction history of the user. In this case, the advertising method may use the verified reaction history of the user to change a landing page of a site according to the search result and/or adding promotion information to the display text of the search result (not shown).

In operation 820, the advertising system 700 may change a display text of the search result when the search result is provided to the user based on the search history of the user. In a case in which the user has been provided with the search result, a probability that the user selects the search result may be decreased. Accordingly, by changing the display text of the search result, it is possible to attract and/or maintain the attention of the user.

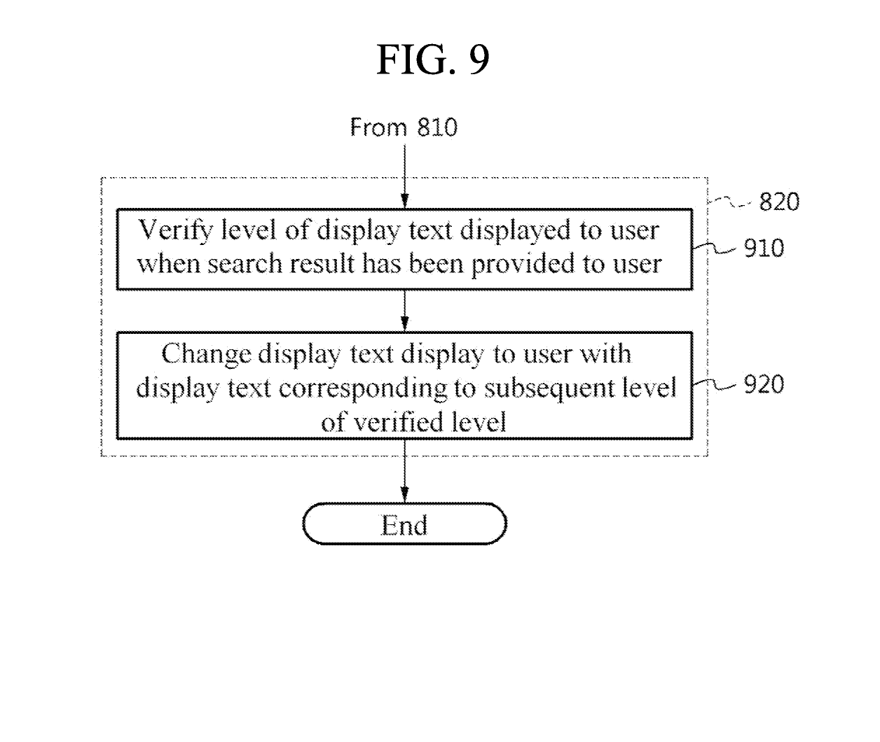

FIG. 9 illustrates an example of a method of changing a display text according to an example embodiment. As described above, changing a display text may include storing a plurality of level-by-level display texts to be matched to a keyword in association with a search result. Thus, operation 820 of the advertising method of FIG. 8 may include operations 910 and 920 of FIG. 9.

In operation 910, the advertising system 700 may verify a level of a display text displayed to the user when the search result has been provided to the user.

In operation 920, the advertising system 700 may change the display text displayed to the user with a display text corresponding to a subsequent level of the verified level of the display text.

To solve an issue that a previously displayed search result is less likely to be selected through its subsequent display, the advertising method according to example embodiments may attract and/or maintain the attention of a user by setting and storing a plurality of level-by-level display texts with respect to a single keyword and providing a display text for each level based on a search history of the user.

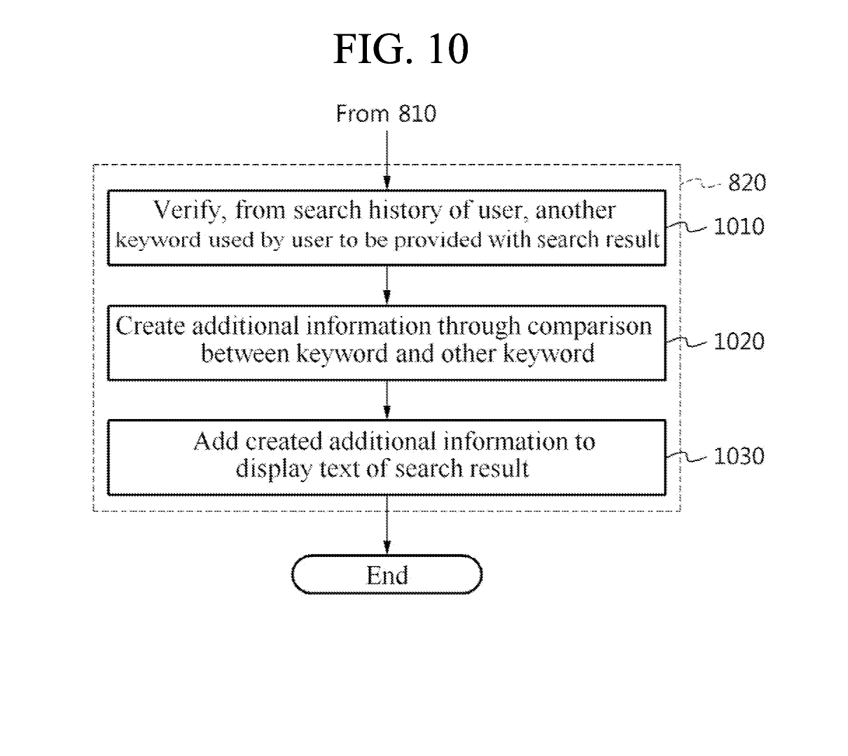

FIG. 10 illustrates another example of a method of changing a display text according to an example embodiment. Operations 1010 through 1030 of FIG. 10 may be included in operation 820 of FIG. 8.

In operation 1010, the advertising system 700 may verify, from the search history of the user, another keyword used by the user to be provided with the search result. As described above, the search history may include information regarding whether a user has been provided with a search result and a keyword to be provided with the search result when the user has been provided with the search result. Accordingly, the search history may include multiple keywords associated with a search result and/or associated with a keyword input into a search engine. In some embodiments, the inputted keywords and/or the other keywords associated with a search result may be ranked and/or organized in a hierarchical fashion.

In operation 1020, the advertising system 700 may create additional information through a comparison between the input keyword (e.g., as verified in operation 810) and the other keyword (e.g., as verified in operation 1010). For example, a term absent in the input keyword and present in the other keyword may be created as additional information.

In operation 1030, the advertising system 700 may add the created additional information to the display text of the search result. Therefore, it is possible to ensure that the search result meets the needs of the user.

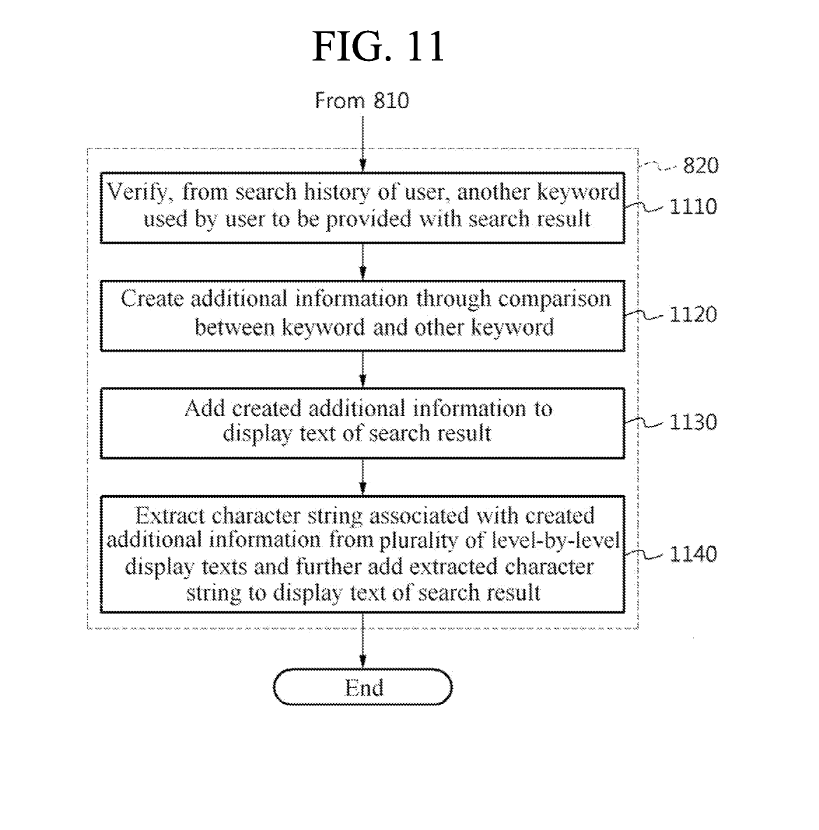

FIG. 11 illustrates still another example of a method of changing a display text according to an example embodiment. As discussed above, changing a display text may include storing a plurality of level-by-level display texts to be matched to a keyword in association with a search result. Thus, it may be advantageous for the advertising method of FIG. 8 to further include storing a plurality of level-by-level display texts to be matched to a keyword in association with a search result. Accordingly, operations 1110 through 1140 of FIG. 11 may be included in operation 820 of FIG. 8.

Operations 1110 through 1130 are the same or similar as operations 1010 through 1030 of FIG. 10, as discussed above.

In operation 1140, the advertising system 700 may extract a character string associated with the created additional information from the plurality of level-by-level display texts, and further add the extracted character string to the display text of the search result. That is, as described above with reference to FIG. 10, the advertising system 700 may create additional information and add the created additional information to the display text of the search result. In this instance, the advertising system 700 may extract a character string associated with the additional information from the plurality of level-by-level display texts and then further add the extracted character string to the display text.

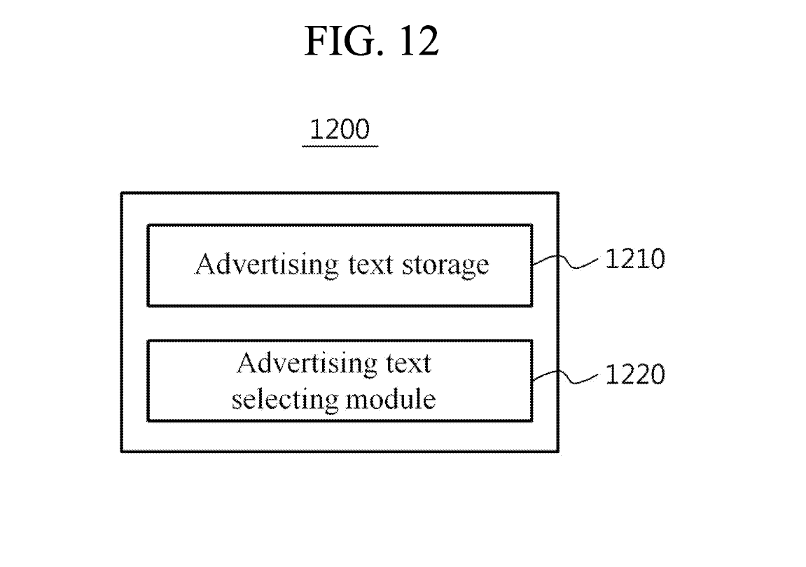

FIG. 12 illustrates an internal configuration of an advertising system 1200 according to another example embodiment. Referring to FIG. 12, the advertising system 1200 may include an advertising text storage 1210 and an advertising text selecting module 1220. The advertising system 1200 may include one or more physical hardware devices, such that the modules of advertising system 1200 may be implemented by one or more processors and/or in combination with one or more storage devices, or by other like hardware devices.

The advertising text storage 1210 may receive and store a plurality of level-by-level advertising texts from an advertiser. The advertising texts may be associated with one or more keywords. That is, the advertiser may input advertising texts desired to be displayed for a level of a level-by-level advertising scheme, and the advertising system 1200 may receive and store the plurality of level-by-level advertising texts.

The advertising text selecting module 1220 may select a single advertising text from among the plurality of level-by-level advertising texts based on at least one of a search history of a user and a reaction history of the user. That is, instead of displaying the same advertising text as a search result repeatedly provided to a user, it is possible to attract the intention of the user by displaying a different advertising text based on a search history of the user and a reaction history of the user.

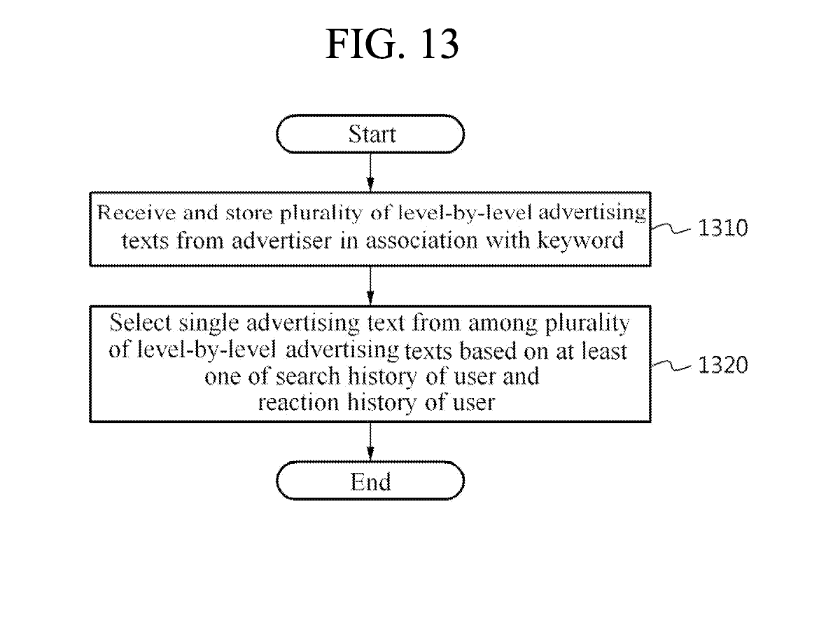

FIG. 13 illustrates an advertising method according to another example embodiment. The advertising method of FIG. 13 may be performed by the advertising system 1200 of FIG. 12.

In operation 1310, the advertising system 1200 may receive and store a plurality of level-by-level advertising texts from an advertiser in association with a keyword. That is, the advertiser may input advertising texts desired to be displayed for the respective levels, and the advertising system 1200 may receive and store the plurality of level-by-level advertising texts.

In operation 1320, the advertising system 200 may select a single advertising text from among the plurality of level-by-level advertising texts based on at least one of a search history of a user and a reaction history of the user. That is, instead of displaying the same advertising text as a search result repeatedly provided to a user, it is possible to attract the attention of the user by displaying a different advertising text based on a search history of the user and a reaction history of the user.

According to example embodiments, it is possible to change and thereby provide an advertising text in stages based on a variety of conditions by setting a plurality of stage-by-stage advertising texts for each keyword, or to provide an advertising text in which additional information is added. Thus, it is possible to improve an advertising effect.

The modules described herein may be implemented using hardware components, software components, or a combination thereof. For example, a processing device may be implemented using one or more general-purpose or special purpose computers, such as, for example, a processor, a controller and an arithmetic logic module, a digital signal processor, a microcomputer, a field programmable array, a programmable logic module, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable recording mediums.

The example embodiments may be recorded in non-transitory computer-readable media including program instructions to implement various operations embodied by a computer. The media may also include, alone or in combination with the program instructions, data files, data structures, and the like. The media and program instructions may be those specially designed and constructed for the purposes, or they may be of the kind well-known and available to those having skill in the computer software arts. Examples of non-transitory computer-readable media include magnetic media such as hard disks, floppy disks, and magnetic tape; optical media such as CD ROM disks and DVD; magneto-optical media such as optical disks; and hardware devices that are specially to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be to act as one or more software modules in order to perform the operations of the above-described embodiments.

It will be apparent to those skilled in the art that various modifications and variation can be made in the example embodiments without departing from the spirit or scope of the invention. Thus, it is intended that the example embodiments cover the modifications and variations of this invention provided they come within the scope of the appended claims and their equivalents.

What is claimed is:

1. An advertising method, comprising:
determining, by a processor, a search history of a user, the determining being based on a search result provided to the user in response to a received input keyword; and
changing, by the processor, a display text associated with the search result if the determining determines that the search result has been previously provided to the user.

2. The method of claim 1, further comprising:
storing a plurality of level-by-level display texts, each of the plurality of level-by-level display texts including a level; and
matching each of the plurality of level-by-level display texts with the input keyword.

3. The method of claim 2, wherein the changing comprises:
determining a level of the display text associated with the search result, the display text being one of the plurality of level-by-level display texts; and
displaying another one of the plurality of level-by-level display texts, the other one of the plurality of level-by-level display texts being associated with the search result and having a subsequent level to the determined level.

4. The method of claim 1, wherein the changing comprises:
determining another keyword associated with the input keyword, the other keyword being based on the search history of the user;
creating additional information based on a comparison of the input keyword and the other keyword; and
adding the additional information to the display text associated with the search result.

5. The method of claim 2, wherein the changing comprises:
determining another keyword associated with the input keyword, the other keyword being based on the search history of the user;
creating additional information based on a comparison of the input keyword and the other keyword;
extracting a character string from at least one of the plurality of level-by-level display texts, the extracted character string being associated with the additional information; and
adding the additional information and the extracted character string to the display text associated with the search result.

6. The method of claim 1, wherein the determining comprises:
determining a reaction history of the user; and
changing a landing page of a site based on the search result and the reaction history.

7. The method of claim 6, wherein the determining further comprises:
determining a reaction history of the user; and
adding promotion information to the display text of the search result using the determined reaction history.

8. The method of claim 6, wherein the reaction history of the user includes at least one of a site selection, an amount of time the user visits a site, a page viewed within a site, and an occurrence of conversion.

9. An advertising system, comprising:
a processor including a search history verifying module configured to determine a search history of a user, the determination is based on a search result provided to the user in response to an input keyword; and
the processor including a display text changing module configured to change a display text associated with the search result if the search history verifying module verifies that the search result has been previously provided to the user.

10. The advertising system of claim 9, further comprising:
a database including a display text storage configured to store a plurality of level-by-level display texts, each of the plurality of level-by-level display texts include a level, each of the plurality of level-by-level display texts are matched with the input keyword, and
the display text changing module is configured to determine a level of the display text, and to display another one of the plurality of level-by-level display texts, the display text is one of the plurality of level-by-level display texts, the other one of the plurality of level-by-level display texts is associated with the search result and has a subsequent level to the determined level.

11. The advertising system of claim 9, wherein the display text changing module is configured to
determine another keyword associated with the input keyword to be provided with the search result, the other keyword being based on the search history of the user,
create additional information based on a comparison of the input keyword and the other keyword, and
add the additional information to the display text associated with the search result.

12. The advertising system of claim 9, further comprising:
a database including a display text storage configured to store a plurality of level-by-level display texts, each of the plurality of level-by-level display texts include a level, each of the plurality of level-by-level display texts are matched with the input keyword, and
the display text changing module is configured to
determine another keyword associated with the input keyword to be provided with the search result, the other keyword being based on the search history of the user,
create additional information based on a comparison of the input keyword and the other keyword,
extract a character string from at least one of the plurality of level-by-level display texts, the extracted character string being associated with the additional information, and
add the additional information and the extracted character string to the display text associated with the search result.

13. The advertising system of claim 9, wherein
the search history verifying module is further configured to determine a reaction history of the user, and
the processor further comprises an extending and changing module configured to change a landing page of a site based on the search result and the search history.

14. The advertising system of claim 13, wherein the extending and changing module is further configured to add promotion information to the display text of the search result using the verified reaction history of the user.

15. An advertising method, comprising:
storing, by a processor, a received plurality of level-by-level advertising texts from an advertiser associated with a keyword, each of the plurality of level-by-level advertising texts including a level; and
selecting, by the processor, a single advertising text from among the plurality of level-by-level advertising texts based on a search result to be provided to a user and at least one of a search history of the user and a reaction history of the user.

16. The method of claim 15, wherein the selecting comprises:
determining a level of a display text to be displayed to the user, the display text being based on a search result, the search result being based on an input keyword; and
displaying another display text having a subsequent level to the determined level, the displaying being based on at least one of the search history and the reaction history, the other display text being the selected advertising text.

17. The method of claim 15, further comprising:
determining another keyword to be provided with the search result, the other keyword being based on the search history of the user;
creating additional information based on a comparison of the keyword and the other keyword; and
adding the additional information to the display text associated with the search result.

18. The method of claim 15, further comprising:
determining another keyword to be provided with the search result, the other keyword being based on the search history of the user;
creating additional information based on a comparison of the keyword and the other keyword; and
extracting a character string associated with the additional information from the plurality of level-by-level advertising texts and further adding the extracted character string to the selected advertising text.

19. The method of claim 15, further comprising:
adding promotion information to the selected advertising text, the promotion information being based on the reaction history of the user.

20. The method of claim 15, wherein the reaction history of the user includes at least one of a site selection, an amount of time the user visits a site, a page viewed within a site, and an occurrence of conversion.

21. A method for providing a display text with a search result, the method comprising:
receiving, by a processor, an input keyword provided by a user, the input keyword being associated with a display text;
receiving, by the processor, a search result based on the input keyword;
determining, by the processor, whether the search result and the display text have been previously provided to the user based on a search history of the user; and
providing, by the processor, the search result and another display text if the determining determines that the display text has been previously provided to the user.

22. The method of claim 21, wherein
the display text includes a rank and the other display text includes a rank, and
the rank of the other display text is lower than the rank of the display text.

23. The method of claim 21, further comprising:
determining another keyword associated with the input keyword, the other keyword being based on the search history of the user; and
creating additional information based on a comparison of the input keyword and the other keyword; and
providing the additional information with the search result.

24. The method of claim 23, wherein the display text and the other display text are among a plurality of display texts, and the method further comprises:
extracting a character string from at least one of the plurality of display texts, the extracted character string being associated with the additional information; and
providing the additional information and the extracted character string with the search result.

25. The method of claim 21, further comprising:
determining a reaction history of the user;
generating promotion information based on the reaction history; and
providing the promotion information with the search result.
